(19) United States
(12) Patent Application Publication
(10) Pub. No.: US 2014/0032708 A1
(43) Pub. Date: Jan. 30, 2014

(54) PROVIDING ONLINE CONTENT

(71) Applicants: Oren Eli Zamir, Los Altos, CA (US); Ting Liu, Sunnyvale, CA (US)

(72) Inventors: Oren Eli Zamir, Los Altos, CA (US); Ting Liu, Sunnyvale, CA (US)

(21) Appl. No.: 13/746,980

(22) Filed: Jan. 22, 2013

(30) Foreign Application Priority Data
Jul. 24, 2012 (IL) 221093

(51) Int. Cl. H04L 29/08

(52) U.S. Cl. CPC H04L 67/10
USPC 709/217

(57) ABSTRACT

Systems and methods for providing online content include analyzing history data indicative of visited webpages. Topics of the visited webpages may be analyzed to identify an interest category from which content may be provided. A visited webpage may also be analyzed to determine a geographic location associated with an interest category. The interest category and its associated geographic location may be used to generate an interest category profile. Content may be selected and provided to a device based in part on the IC profile.

### RELATED APPLICATIONS

The present disclosure claims foreign priority to Israeli Patent Application No. 221,093, entitled “PROVIDING ONLINE CONTENT,” filed Jul. 24, 2012, the entirety of which is hereby incorporated by reference.

### BACKGROUND

The present disclosure relates generally to providing online content. The present disclosure more specifically relates to dynamically providing content based on its potential relevance to a user.

Websites and other online sources may provide content to client devices relating to any number of different topics. For example, a first website may be devoted the latest golf equipment and a second website may be devoted to automobiles. Users having an interest in a particular topic may navigate to an online content source related to that topic. In some cases, a user may utilize a search engine to find online content of interest to the user. For example, a user may search the Internet for reviews of the latest golf equipment and the search engine may return a listing of websites devoted to reviewing golf equipment. The user may navigate between the various websites in the listing to receive content of relevance to the user.

### SUMMARY

Implementations of the systems and methods for providing online content are disclosed. Some implementations involve a computerized method for providing online content. The method includes receiving, at a processing circuit, history data indicative of a webpage visited by a user identifier. The method also includes analyzing, by the processing circuit, the history data to identify an interest category based in part on a topic of the webpage. The method further includes analyzing, by the processing circuit, the history data to identify a geographic location based in part on the webpage. The method yet further includes associating the geographic location with the interest category and generating an interest category profile for the user identifier. The interest category profile includes the identified interest category and associated geographic location. The method also includes selecting content for the user identifier based in part on the interest category profile and providing the selected content to a device associated with the user identifier.

Another implementation is a system for providing online content. The system includes a processing circuit operable to receive history data indicative of a webpage visited by a user identifier and to analyze the history data to identify an interest category based in part on a topic of the webpage. The processing circuit is also operable to analyze the history data to identify a geographic location based in part on the webpage and to associate the geographic location with the interest category. The processing circuit is further operable to generate an interest category profile for the user identifier. The interest category profile includes the identified interest category and associated geographic location. The processing circuit is also operable to select content for the user identifier based in part on the interest category profile and to provide the selected content to a device associated with the user identifier.

A further implementation is a computer-readable medium having machine instructions stored therein, the instructions being executable by a processor to cause the processor to perform operations. The operations include receiving history data indicative of a webpage visited by a user identifier and analyzing the history data to identify an interest category based in part on a topic of the webpage. The operations also include analyzing the history data to identify a geographic location based in part on the webpage and associating the geographic location with the interest category. The operations further include generating an interest category profile for the user identifier. The interest category profile includes the identified interest category and associated geographic location. The operations yet further include selecting content for the user identifier based in part on the interest category profile and providing the selected content to a device associated with the user identifier.

These implementations are mentioned not to limit or define the scope of this disclosure, but to provide examples of implementations to aid in understanding thereof.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block diagram of a computer system in accordance with a described example;

FIG. 2 is an illustration of an electronic display showing an example webpage;

FIG. 3 is an example illustration of content being included with a webpage by a content selection server;

FIG. 4 is an example process for providing online content using an interest category (IC) profile;

FIG. 5 is an illustration of an example of a webpage being analyzed to identify an interest category and a geographic location; and

FIG. 6 is an example illustration of an IC profile being generated.

Like reference numbers and designations in the various drawings indicate like elements.

### DETAILED DESCRIPTION

According to some aspects of the present disclosure, online content of relevance to a user may be selected automatically by analyzing online events involving the user. In other words, topics of interest to the user may be identified by a computing system and used to select content that may be interest to the user. Thus, a particular user's online experience can be enhanced by providing content that is tailored to the user, if the user elects to receive content that may be of interest to him or her. For example, a user that visits a number of webpages devoted to reviews of golf clubs may be identified as having an interest in golf. Content related to golf may then be selected by the computing system and provided to a device of the user.

A user that elects to receiving relevant content may be represented as a user identifier within a computing system. As used herein, a user identifier refers to any form of data that may be used within a computing system to uniquely represent a user. In some implementations, a user identifier may be associated with one or more client identifiers (e.g., a device serial number, a network address, a cookie, etc.). For example, a user identifier may be associated with client identifiers for both a user's mobile telephone and home computer. In other implementations, a user identifier may be a client identifier itself. A user identifier and/or a client identifier may further be anonymized and contain no personally-identifiable information about the user (e.g., the user's name, address, etc.).

Content requested by a user identifier may be analyzed to determine one or more topics of the content. For example, keywords on a webpage may be analyzed to determine that the webpage is devoted to the topic of golf. In some implementations, topics may be organized using predefined interest categories. For example, the topic of golf may be classified within the interest category of Golf, Competitive Sports, Sports, or Recreation. In some cases, a taxonomy may be used to organize the interest categories. For example, the topic of golf may be classified within the interest category of /Entertainment/Sports/Golf, /Sports/Individual Sports/Golf, or /Individual Sports/Golf.

According to various implementations, an interest category may be associated with a geographic location. For example, an interest category relating to travel may be associated with the geographic location of Hawaii. In some implementations, the geographic location may be identified by analyzing the same webpage or webpages analyzed to determine the interest category. In other words, the geographic location associated with an interest category may be based on one or more webpages visited by a user identifier. Such an identification may be made without regard to the actual location of the user and the two locations may or may not coincide. Similar to interest categories, a taxonomy may be used to organize the geographic locations. For example, Hawaii may be classified as /World Localities/North America/USA/Hawaii, /US States/Hawaii, or /Pacific Ocean/Hawaii. Therefore, in some implementations, an identified geographic location may fall within a predefined geographic location category.

An interest category (IC) profile may be generated and associated with a user identifier. In general, an IC profile may represent a particular user's interests. For example, an IC profile may include interest categories related to golf, parasailing, and philately. In some cases, an IC profile may be generated by combining identified interest categories across different time periods. For example, a user's online history, collected with the user's permission, may be analyzed to identify long-term, short-term, and/or current interest categories for the user's IC profile. In some implementations, interest categories may be weighted, to select which interest categories are to be included in the generated IC profile. A weighting may be based on, for example, a strength score for the interest category (e.g., a score representing how strongly the user is interested in the category) and/or a decay function (e.g., a function modeling how likely the user is to lose interest in the category over time).

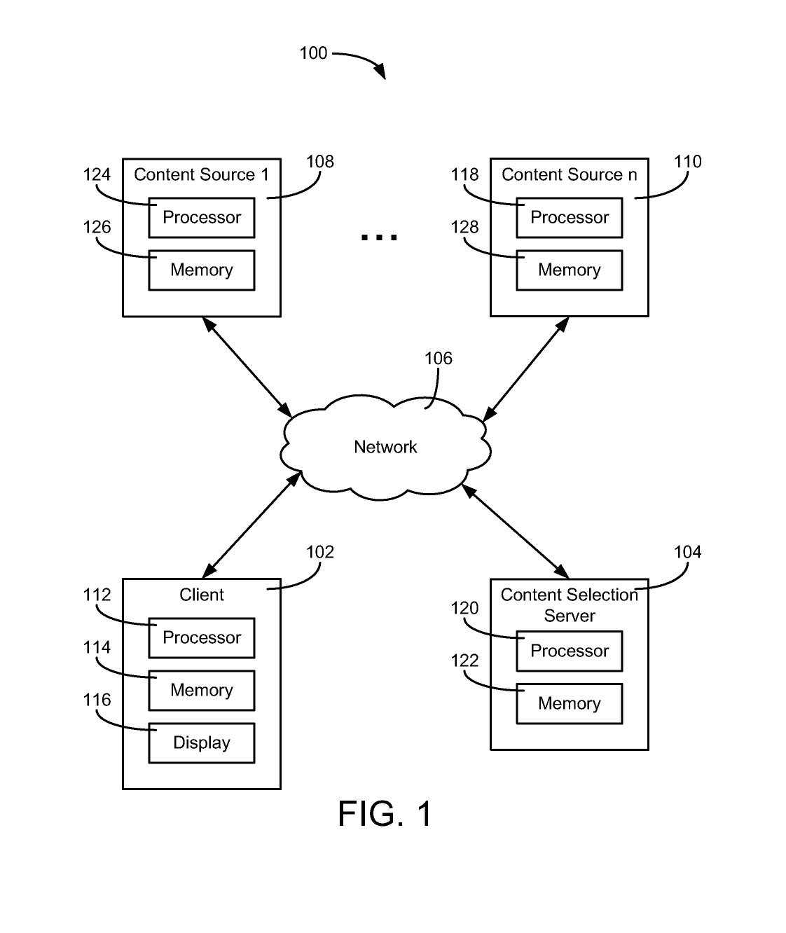

Referring to FIG. 1, a block diagram of a computer system 100 in accordance with a described implementation is shown. System 100 includes a client 102 which communicates with other computing devices via a network 106. Client 102 may execute a web browser or other application (e.g., a video game, a channel guide for streaming content, a media player, etc.) to retrieve content from other devices over network 106. For example, client 102 may communicate with any number of content sources 108, 110 (e.g., a first content source through nth content source). Content sources 108, 110 may provide webpage data and/or other content (e.g., text documents, PDF files, and other forms of electronic documents) to client 102. In some implementations, computer system 100 may also include a content selection server 104 configured to select content to be provided to client 102. For example, content source 108 may provide a webpage to client 102 that includes additional content selected by content selection server 104 based in part on the content's potential relevancy to the user of client 102.

Network 106 may be any form of computer network that relays information between client 102, content sources 108, 110, and content selection server 104. For example, network 106 may include the Internet and/or other types of data networks, such as a local area network (LAN), a wide area network (WAN), a cellular network, satellite network, or other types of data networks. Network 106 may also include any number of computing devices (e.g., computer, servers, routers, network switches, etc.) that are configured to receive and/or transmit data within network 106. Network 106 may further include any number of hardwired and/or wireless connections. For example, client 102 may communicate wirelessly (e.g., via WiFi, cellular, radio, etc.) with a transceiver that is hardwired (e.g., via a fiber optic cable, a CAT5 cable, etc.) to other computing devices in network 106.

Client 102 may be any number of different types of user electronic devices configured to communicate via network 106 (e.g., a laptop computer, a desktop computer, a tablet computer, a smartphone, a digital video recorder, a set-top box for a television, a video game console, combinations thereof, etc.). Client 102 is shown to include a processor 112 and a memory 114, i.e., a processing circuit. Memory 114 may store machine instructions that, when executed by processor 112 cause processor 112 to perform one or more of the operations described herein. Processor 112 may include a microprocessor, ASIC, FPGA, etc., or combinations thereof. Memory 114 may include, but is not limited to, electronic, optical, magnetic, or any other storage or transmission device capable of providing processor 112 with program instructions. Memory 114 may include a floppy disk, CD-ROM, DVD, magnetic disk, memory chip, ROM, RAM, EEPROM, EPROM, flash memory, optical media, or any other suitable memory from which processor 112 can read instructions. The instructions may include code from any suitable computer programming language such as, but not limited to, C, C++, C#, Java, JavaScript, Perl, HTML, XML, Python and Visual Basic.

Client 102 may include one or more user interface devices. A user interface device may be any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more user interface devices may be internal to the housing of client 102 (e.g., a built-in display, microphone, etc.) or external to the housing of client 102 (e.g., a monitor connected to client 102, a speaker connected to client 102, etc.), according to various implementations. For example, client 102 may include an electronic display 116, which displays webpages and other data received from content sources 108, 110 and/or content selection server 104. In various implementations, electronic display 116 may be located inside or outside of the same housing as that of processor 112 and/or memory 114. For example, electronic display 116 may be an external display, such as a computer monitor, television set, or any other stand-alone form of electronic display. In other examples, electronic display 116 may be integrated into the housing of a laptop computer, mobile device, or other form of computing device having an integrated display.

Content sources 108, 110 may be one or more electronic devices connected to network 106 that provide content to client 102. For example, content sources 108, 110 may be computer servers (e.g., FTP servers, file sharing servers, web servers, etc.) or combinations of servers (e.g., data centers, cloud computing platforms, etc.). Content may include, but is not limited to, webpage data, a text file, a spreadsheet, images, search results, and other forms of electronic documents. Similar to client 102, content sources 108, 110 may include processing circuits comprising processors 124, 118 and memories 126, 128, respectively, that store program instructions executable by processors 124, 118. For example, the processing circuit of content source 108 may include instructions such as web server software, FTP serving software, and other types of software that cause content source 108 to provide content via network 106.

According to various implementations, content sources 108, 110 may provide webpage data to client 102 that includes one or more content tags. In general, a content tag may be any piece of webpage code associated with the action of including content with a webpage. According to various implementations, a content tag may define a slot on a webpage for additional content, a slot for out of page content (e.g., an interstitial slot), whether content should be loaded asynchronously or synchronously, whether the loading of content should be disabled on the webpage, whether content that loaded unsuccessfully should be refreshed, the network location of a content source that provides the content (e.g., content sources 108, 110, content selection server 104, etc.), a network location (e.g., a URL) associated with clicking on the content, how the content is to be rendered on a display, a command that causes client 102 to set a browser cookie (e.g., via a pixel tag that sets a cookie via an image request), one or more keywords used to retrieve the content, and other functions associated with providing additional content with a webpage. For example, content source 108 may provide webpage data that causes client 102 to retrieve content from content selection server 104. In another implementation, content may be selected by content selection server 104 and provided by content source 108 as part of the webpage data sent to client 102.

Similar to content sources 108, 110, content selection server 104 may be one or more electronic devices connected to network 106 that selects content to be provided to client 102 based on a predicted relevancy to the user of client 102. Content selection server 104 may be a computer server (e.g., FTP servers, file sharing servers, web servers, etc.) or a combination of servers (e.g., a data center, a cloud computing platform, etc.). Content selection server 104 may have a processing circuit including a processor 120 and a memory 122 that stores program instructions executable by processor 120. In cases in which content selection server 104 is a combination of computing devices, processor 120 may represent the collective processors of the devices and memory 122 may represent the collective memories of the devices. The processing circuit of content selection server 104 may be configured to conduct an auction to select content to be provided to client 102. For example, content selection server 104 may select content, such as an advertisement, to be provided with a webpage served by content source 108 or 110.

In some implementations, content selection server 104 may be configured to select content based on a user identifier associated with client 102. In general, a user identifier refers to any form of data that may be used to represent a user that has elected to receiving content selected by content selection server 104. In some implementations, a user identifier may be associated with a client identifier that identifies a client device to content selection server 104 or may itself be the client identifier. In various implementations, a user identifier may be associated with multiple client identifiers (e.g., a client identifier for a mobile device, a client identifier for a home computer, etc.). Client identifiers may include, but are not limited to, cookies, device serial numbers, user profile data, telephone numbers, or network addresses. For example, a cookie set on client 102 may be used to identify client 102 to content selection server 104.

Content selection server 104 may use information associated with a user identifier to select content for the represented user, if the user has opted in to the functionality of content selection server 104. For example, content selection server 104 may analyze history data associated with a user identifier to determine one or more potential interest categories for the user identifier. History data may be any data associated with a user identifier that is indicative of an online event (e.g., visiting a webpage, interacting with presented content, conducting a search, making a purchase, downloading content, etc.). Content selection server 104 may select content to be provided in conjunction with other content by client 102 (e.g., as part of a displayed webpage, as a pop-up, within a video game, within another type of application, etc.).

Content selection server 104 may receive history data indicative of one or more online events associated with a user identifier. In implementations in which a content tag causes client 102 to request content from content selection server 104, such a request may include a client identifier for client 102 and/or additional information (e.g., the webpage being loaded, the referring webpage, etc.). Content selection server 104 may store such data to record a history of online events associated with a user identifier. In some cases, client 102 may provide history data to content selection server 104 without first executing a content tag. For example, client 102 may periodically send history data to content selection server 104 or may do so in response to receiving a command from a user interface device. In some implementations, content selection server 104 may receive history data from content sources 108, 110. For example, content source 108 may store history data regarding web transactions with client 102 and provide the history data to content selection server 104.

Content selection server 104 may analyze the history data associated with a user identifier to identify one or more topics. For example, content selection server 104 may perform text and/or image analysis on a webpage from content source 108, to determine one or more topics of the webpage. In some implementations, a topic may correspond to a predefined interest category used by content selection server 104. For example, a webpage devoted to the topic of golf may be classified under the interest category of sports. In some cases, interest categories used by content selection server 104 may conform to a taxonomy (e.g., an interest category may be classified as falling under a broader interest category). For example, the interest category of golf may be /Sports/Golf, /Sports/Individual Sports/Golf, or under any other hierarchical category.

Content selection server 104 may also analyze the history data associated with the user identifier to identify one or more geographic locations. According to various implementations, content selection server 104 may associate the one or more geographic locations with an interest category. Similar to the identification of the interest category, content selection server 104 may use text and/or image analysis on a webpage to identify one or more geographic locations to be associated with an interest category. For example, a webpage devoted to fishing in Seattle visited by the user identifier may be analyzed by content selection server 104 to identify an interest category relating to fishing and the geographic location of Seattle. In such a case, the geographic location of Seattle may be associated with the interest category relating to fishing. In some implementations, geographic locations may conform to a taxonomy, similar to the interest categories. For example, Seattle may fall within the geographic category of /Countries/USA/Washington/Seattle, /Countries/USA/Pacific Northwest/Cities/Seattle, or /World Localities/North America/USA/Seattle.

Using the same history data to identify an interest category and its associated geographic category may prevent an interest category from inadvertently being associated with the wrong geographic category. For example, assume that a user identifier visits webpages devoted to travel to Paris and a webpage with a news article regarding an earthquake in Haiti. Also, assume that a geographic category is identified for an interest category based on all webpage visits by a user identifier, not just travel-related webpage visits. In such a case, an interest category of travel may be inadvertently associated with the geographic category of Haiti instead of Paris. However, if a geographic category is identified by analyzing the same webpages used to identify its associated interest category, an interest category relating to travel may be associated with the location of Paris and an interest category relating to the news may be associated with the location of Haiti.

An interest category for a user identifier may or may not have an associated geographic category. In some implementations, only certain interest categories may be eligible for an associated geographic category. For example, an interest category related to travel may be eligible for an associated geographic category, but an interest category related to philately may not be. An interest category may be limited to any number of associated geographic categories (e.g., one location, two locations, etc.) or may have an unlimited number of associated geographic categories. In various implementations, a weighting may be applied to geographic categories to determine which geographic location is associated with the interest category. For example, assume that a user identifier visited ten webpages devoted to vacations in Hawaii and one webpage devoted to vacations in Seattle. In such a case, the geographic location of Hawaii may receive a higher weighting than Seattle resulting in Hawaii being associated with the interest category of travel for the user identifier.

In some implementations, content selection server 104 may classify the history data as being long-term, short-term, and/or current history data. The different sets of history data may then be analyzed by content selection server 104 to identify an interest category as being a long-term, short-term, or current interest. For example, the webpage being visited by client 102 may be analyzed to determine one or more current interest categories for the user identifier associated with client 102. Short-term history may be any data from an intermediate time period between the current history and long-term history. For example, the short-term history may be from the previous hour or day. Long-term history data may be any data from a time period preceding the short-term time period. For example, long-term history data may be history data regarding actions performed between the previous day and one month prior.

Content selection server 104 may use identified interest categories to generate an IC profile for a user identifier. Such an IC profile may include one or more of the identified interest categories. In some implementations, an IC profile generated by content selection server 104 may be limited to a maximum number of interest categories. In such a case, content selection server 104 may determine an interest category weight for an identified interest category. The weight may be used by content selection server 104 to determine whether to include the interest category in the generated IC profile.

According to various implementations, content selection server 104 may base a weight for an interest category and/or geographic category in part on a decay function. In many cases, a user may lose interest in a topic over the course of time. How quickly a user loses interest may depend on the particular interest category. For example, a user researching gift cards may lose interest in purchasing a gift card faster than if the user researches purchasing a house. Similarly, a geographic category associated with an interest category may change over time for a user identifier. In one example, assume that a user identifier visits webpages devoted to Hawaiian vacations. An interest category relating to travel may then be associated with the geographic category of Hawaii. However, also assume that the user identifier later visits webpages devoted to vacations in Florida and stops researching Hawaiian vacations. By applying a time decay function to the weights of the geographic categories, the location of Hawaii associated with the travel-related interest category may be phased out in favor of the geographic category corresponding to the State of Florida.

Content selection server 104 may use an IC profile for a user identifier associated to select content for client 102. For example, content selection server 104 may select an advertisement to be placed on a webpage provided by content source 108 to client 102, if a topic of the advertisement corresponds to an interest category in the IC profile associated with client 102. In some implementations, content selection server 104 may be configured to allow a plurality of entities to compete for the ability to provide content to client 102. For example, various advertisers may compete in an auction conducted by content selection server 104 to select the content to be provided to client 102. Bids in a content auction conducted by content selection server 104 may be for a simple impression (i.e., the content is displayed to the user of client 102), a click-through (i.e., the user of client 102 clicks on the selected content), or a conversion (i.e., the user of client 102 clicks on the content and performs a desired action on an advertiser's website). In some implementations, content selection server 104 may generate an auction bid on behalf of an auction participant. In other words, the bid may be generated without further action by the participant. For example, an advertiser may provide a daily, weekly, or monthly budget to content selection server 104, as well as certain advertising goals. In response, content selection server 104 may generate bids on behalf of an advertiser to meet the advertiser's budgetary and advertising goals (e.g., number of impressions per day, clicks per day, etc.). The bids may also be based in part on whether an interest category and geographic category in an IC profile match categories specified by the auction participant.

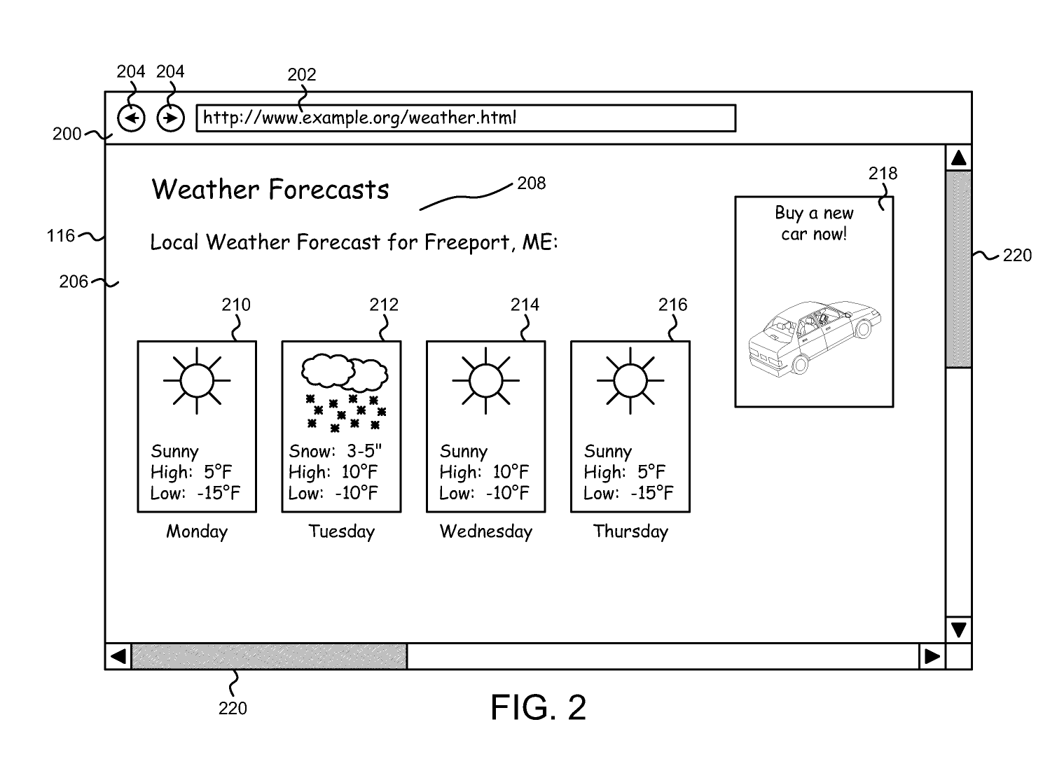

Referring now to FIG. 2, an illustration is shown of electronic display 116 displaying an example webpage 206. Electronic display 116 is in electronic communication with processor 112 which causes visual indicia to be displayed on electronic display 116. As shown, processor 112 may execute a web browser 200 stored in memory 114 of client 102, to display indicia of content received by client 102 via network 106. In other implementations, another application executed by client 102 may incorporate some or all of the functionality described with regard to web browser 200 (e.g., a video game, a chat application, etc.).

Web browser 200 may operate by receiving input of a uniform resource locator (URL) via a field 202 from an input device (e.g., a pointing device, a keyboard, a touch screen, etc.). For example, the URL, http://www.example.org/weather.html, may be entered into field 202. Processor 112 may use the inputted URL to request data from a content source having a network address that corresponds to the entered URL. In response to the request, the content source may return webpage data and/or other data to client 102. Web browser 200 may analyze the returned data and cause visual indicia to be displayed by electronic display 116 based on the data.

In general, webpage data may include text, hyperlinks, layout information, and other data that may be used to provide the framework for the visual layout of webpage 206. In some implementations, webpage data may be one or more files of webpage code written in a markup language, such as the hypertext markup language (HTML), extensible HTML (XHTML), extensible markup language (XML), or any other markup language. For example, the webpage data in FIG. 2 may include a file, “weather.html” provided by the website, “www.example.org.” The webpage data may include data that specifies where indicia appear on webpage 206, such as text 208. In some implementations, the webpage data may also include additional URL information used by web browser 200 to retrieve additional indicia displayed on webpage 206. For example, the file, “weather.html,” may also include one or more instructions used by processor 112 to retrieve images 210-216 from their respective content sources.

Web browser 200 may include a number of navigational controls associated with webpage 206. For example, web browser 200 may be configured to navigate forward and backwards between webpages in response to receiving commands via inputs 204 (e.g., a back button, a forward button, etc.). Web browser 200 may also include one or more scroll bars 220, which can be used to display parts of webpage 206 that are currently off-screen. For example, webpage 206 may be formatted to be larger than the screen of electronic display 116. In such a case, the one or more scroll bars 220 may be used to change the vertical and/or horizontal position of webpage 206 on electronic display 116.

Webpage 206 may be devoted to one or more topics. For example, webpage 206 may be devoted to the local weather forecast for Freeport, Me. In some implementations, a content selection server, such as content selection server 104, may analyze the contents of webpage 206 to identify one or more topics. For example, content selection server 104 may analyze text 208 and/or images 210-216 to identify webpage 206 as being devoted to weather forecasts. In some implementations, webpage data for webpage 206 may include metadata that identifies a topic.

In various implementations, content selection server 104 may select some or all of the content presented on webpage 206. For example, content selection server 104 may select advertisement 218 to be included on webpage 206, based on a user identifier associated with client 102. In some implementations, one or more content tags may be embedded into the code of webpage 206 that defines a content field located at the position of advertisement 218. Another content tag may cause web browser 200 to request additional content from content selection server 104, when webpage 206 is loaded. Such a request may include one or more keywords, a client identifier for client 102, or other data used by content selection server 104 to select content to be provided to client 102. In response, content selection server 104 may select advertisement 218.

Advertisement 218 may be selected based in part on an interest category identified by analyzing history data associated with a client identifier for client 102. For example, assume that the user of web browser 200 researched various makes and models of automobiles. Data regarding the research may be analyzed by content selection server 104 to identify automobiles as a potential interest category. In some implementations, the interest category of automobiles may be included in an IC profile for the user identifier. Advertisers for automobiles may then compete in an auction to determine which advertiser is able to provide an advertisement to client 102. Thus, advertisement 218 may be provided on webpage 206 based on a potential interest of the user of client 102 (e.g., automobiles), without regard to the actual topic of webpage 206 (e.g., a weather forecast).

In some implementations, content selection server 104 may provide advertisement 218 directly to client 102. In other implementations, content selection server 104 may send a command to client 102 that causes client 102 to retrieve advertisement 218. For example, the command may cause client 102 to retrieve advertisement 218 from a local memory, if advertisement 218 is already stored in memory 114, or from a networked content source. In this way, any number of different pieces of content may be placed in the location of advertisement 218 on webpage 206. In other words, one user that visits webpage 206 may be presented with advertisement 218 and a second user that visits webpage 206 may be presented with different content. Other forms of content (e.g., an image, text, an audio file, a video file, etc.) may be selected by content selection server 104 for display with webpage 206 in a manner similar to that of advertisement 218. In further implementations, content selected by content selection server 104 may be displayed outside of webpage 206. For example, content selected by content selection server 104 may be displayed in a separate window or tab of web browser 200, may be presented via another software application (e.g., a text editor, a media player, etc.), or may be downloaded to client 102 for later use.

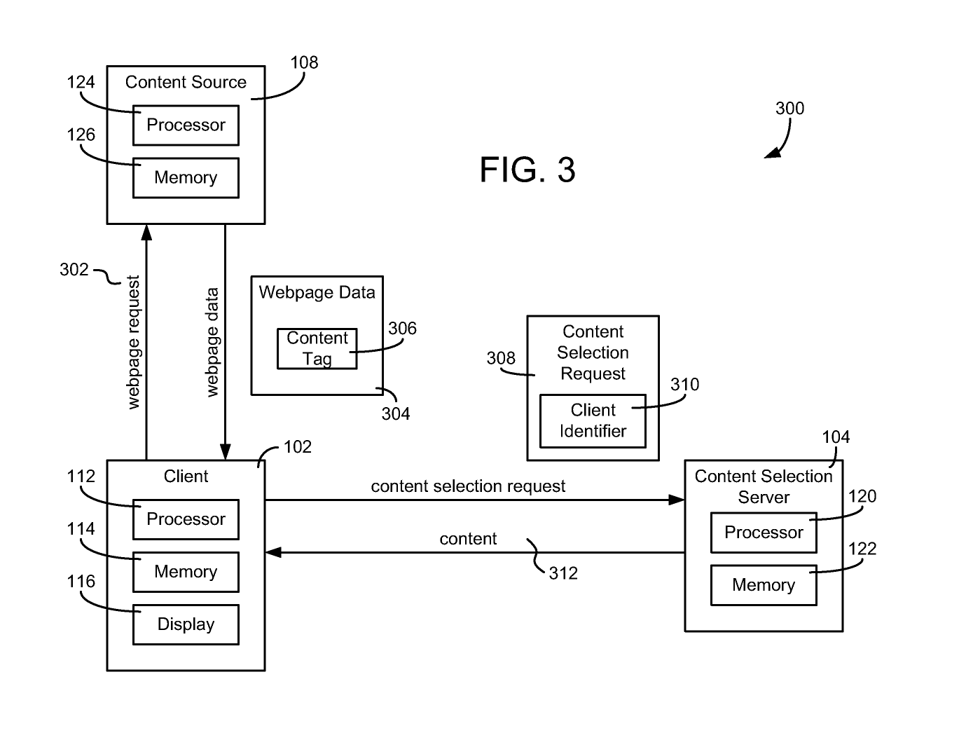

FIG. 3 is an example illustration of content 312 being selected by content selection server 104. As shown, client 102 may send a webpage request 302 to a content source via network 106, such as content source 108. For example, webpage request 302 may be a request that conforms to the hypertext transfer protocol (HTTP), such as the following:

GET/weather.html HTTP/1.1

Host: www.example.org

Such a request may include the name of the file to be retrieved, weather.html, as well as the network location of the file, www.example.org. In some cases, a network location may be an IP address or may be a domain name that resolves to an IP address of content source 108. In some implementations, a client identifier, such as a cookie associated with content source 108, may be included with webpage request 302 to identify client 102 to content source 108.

In response to receiving webpage request 302, content source 108 may return webpage data 304, such as the requested file, “weather.html.” Webpage data 304 may be configured to cause client 102 to display a webpage on electronic display 116 when opened by a web browser application. In some cases, webpage data 304 may include code that causes client 102 to request additional files to be used as part of the displayed webpage. For example, webpage data 304 may include an HTML image tag of the form:

<img src=“Monday_forecast.jpg”>

Such code may cause client 102 to request the image file “Monday_forecast.jpg,” from content source 108.

In some implementations, webpage data 304 may include content tag 306 configured to cause client 102 to retrieve an advertisement from content selection server 104. In some cases, content tag 306 may be an HTML image tag that includes the network location of content selection server 104. In other cases, content tag 306 may be implemented using a client-side scripting language, such as JavaScript. For example, content tag 306 may be of the form:

<script type= ‘text/javascript’>
AdNetwork_RetrieveAd(“argument”)
</script>

where AdNetwork_RetrieveAd is a script function that causes client 102 to send a content selection request 308 to content selection server 104. In various implementations, the argument of the script function may include the network address of content selection server 104, the referring webpage, and/or additional information that may be used by content selection server 104 to select content to be included with the webpage.

Content selection request 308 may include a client identifier 310, used by content selection server 104 to identify client 102. In various implementations, client identifier 310 may be an HTTP cookie previously set by content selection server 104 on client 102, the IP address of client 102, a unique device serial for client 102, other forms of identification information, or combinations thereof. For example, content selection server 104 may set a cookie that includes a unique string of characters on client 102 when content is first requested by client 102 from content selection server 104. Such a cookie may be included in subsequent content selection requests sent to content selection server 104 by client 102. According to various implementations, content selection server 104 may use client identifier 310 as a user identifier or associate client identifier 310 with a user identifier. For example, content selection server 104 may represent the user of client 102 as an HTTP cookie.

In some implementations, client identifier 310 may be used by content selection server 104 to store history data for client 102, with the permission of the user of client 102. For example, content selection request 308 may include data relating to which webpage was requested by client 102, when the webpage was requested, and/or other history data. Whenever client 102 visits a webpage that allows content selection server 104 to select content to appear in conjunction with the webpage, content selection server 104 may receive and store history data for client 102. In this way, content selection server 104 is able to reconstruct the online history of client 102 regarding webpages that utilize content selection server 104. In some implementations, content selection server 104 may also receive history data for client 102 from content sources that do not use its content selection services. For example, a website that does not use content selected by content selection server 104 may nonetheless provide information about client 102 visiting the website to content selection server 104, if the user has opted in to receiving relevant content selected by content selection server 104.

In some cases, client identifier 310 may be sent to content selection server 104 when a particular online event occurs. For example, webpage data 304 may include a content tag 306 that causes client 102 to send client identifier 310 to content selection server 104 when a displayed advertisement is clicked by the user of client 102. Client identifier 310 may also be used to record information after client 102 is redirected to another webpage. For example, client 102 may be redirected to an advertiser's website if the user selects a displayed advertisement. In such a case, client identifier 310 may also be used to record which actions were performed on the advertiser's website. For example, client identifier 310 may be sent to content selection server 104 as the user of client 102 navigates within the advertiser's website. In this way, data regarding whether the user searched for a product, added a product to a shopping cart, completed a purchase on the advertiser's website, etc., may also be recorded by content selection server 104.

Content selection server 104 may analyze history data associated with client identifier 310 to identify one or more interest categories and to generate an IC profile for the user identifier associated with client 102. For example, content selection request 308 may identify one or more themes of the webpage being requested (e.g., content tag 306 includes information regarding the theme of the webpage). In another example, content selection server 104 may perform text analysis and/or image analysis on the webpage to detect one or more themes of the webpage. In further implementations, the requested webpage may be a webpage of a search engine. In such a case, one or more search terms may be used by content selection server 104 to identify an interest category. According to some implementations, content selection server 104 may classify history data as being long-term, short-term, and/or current. The different types of history data may then be analyzed by content selection server 104 to identify long-term, short-term, and/or current interest categories. Content selection server 104 may use any identified interest categories to then generate an IC profile that includes one or more identified interest categories. Such an IC profile may then be used by content selection server 104 to select content for client 102 based in part on the one or more interest categories in the profile.

According to various implementations, content selection server 104 may analyze the history data associated with client identifier 310 to identify one or more geographic categories for an interest category. In some implementations, an identified interest category may be associated with the one or more identified geographic categories. For example, a travel-related interest category may be associated with a potential destination based on the text and/or images on a webpage visited by client identifier 310. In some implementations, only the history data used to identify an interest category may be analyzed to identify geographic categories to be associated with the interest category. For example, only the webpages that indicated the interest category may be analyzed to determine whether a geographic location is to be associated with that interest category. In some cases, an interest category may not have an associated geographic category (e.g., the interest category may be ineligible for an associated geographic category, a webpage that indicated the interest category may not be related to a geographic category, etc.).

In response to receiving content selection request 308, content selection server 104 may select content 312 to be returned to client 102 and included as part of the displayed webpage. For example, content selection server 104 may select content 312 based on one or more themes of the requested webpage (e.g., by content selection server 104 identifying keywords in the content of the webpage, themes included as part of content selection request 308, etc.). Content selection server 104 may also select content 312 using client identifier 310. In some implementations, content selection server 104 may match client identifier 310 to an IC profile. If a topic of content 312 is related to an interest category in the IC profile, content selection server 104 may select 312 to be provided to client 102.

In some cases, content selection server 104 may be configured to run a content auction in which content providers, such as advertisers, compete to provide content to client 102. For example, if the IC profile for the user identifier associated with client 102 includes the interest category of airline tickets, an advertiser that sells airline tickets may bid in such an auction to provide an advertisement to client 102. According to some implementations, the advertiser may also specify one or more geographic categories for the interest category related to airline tickets. The specified geographic category may be broader or narrower than the geographic category associated with the interest category. If the IC profile associated with client identifier 310 includes the interest category and one of the geographic categories, the advertiser may participate in the content auction.

In response to receiving content 312, client 102 may then embed the advertisement or other form of content into the webpage displayed by electronic display 116. In some implementations, content selection server 104 may instead select an advertisement or other form of content already stored on client 102 and provide an indication of the selection to client 102. In response, client 102 may retrieve the pre-stored content from memory 114 and display the content in conjunction with the displayed webpage (e.g., as part of the webpage, in a separate window or tab, etc.).

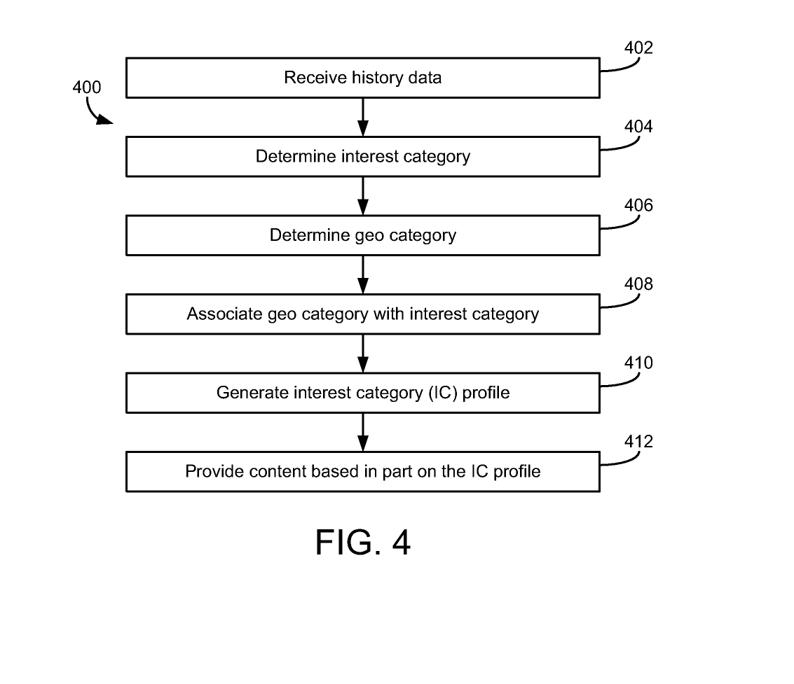

Referring now to FIG. 4, an example process 400 for providing online content using an IC profile is shown, according to various implementations. Process 400 may be implemented by a content selection server or other computing device having access to history data for a user identifier. For example, content selection server 104 shown in FIGS. 1-3 may implement process 400 by executing stored machine instructions. In various implementations, an IC profile may include one or more interest categories identified by analyzing the history data. The history data may also be analyzed to identify one or more geographic categories to be associated with one of the identified interest categories.

Process 400 includes receiving history data associated with a user identifier (block 402). In general, history data refers to information regarding which webpages were visited by one or more client devices and any actions performed regarding the webpages. Such information may be provided on an opt-in basis (i.e., the corresponding user has opted in to allowing the history data to be collected). In some cases, history data may be received from a plurality of client devices associated with the user identifier. For example, a user may conduct a web search for baseball using his mobile phone and visit a webpage devoted to golf using his home computer. In some implementations, the history data for each client identifier associated with a user identifier may be aggregated. For example, a user identifier associated with the mobile phone and home computer may be associated with history data indicative of both a web search for baseball and a visit to a golf-related webpage.

In some implementations, the online history data may be received as part of a request for an advertisement or other content. For example, a client identifier may be provided to a content selection server as part of a content selection request. Such a request may also include the URL or other network address of the webpage on which the requested content is to be placed. In some cases, the history data may include a timestamp indicative of when the webpage was requested by a client device. If no timestamp is included in the online history data, a timestamp corresponding to when the content selection request is received may be associated with it. In one example, the history data may indicate that a mobile phone requested the webpage http://www.example.org/weather.html on Aug. 11, 2014 at 3:35 PM EST.

In further implementations, some or all of the history data may be provided by a third-party entity. For example, some of the history data may be received by a content selection server from a website that does not use content selected by the content selection server. In another example, some or all of the history data may be received from a device that analyzes Internet traffic. In some implementations, some or all of the history data may be provided manually from a client device (i.e., in response to receiving a request to do so from a user interface device). For example, a user may opt in to periodically sending her history data to a content selection server, so that the content selection server can select content in which she may be interested.

Process 400 includes analyzing the history data to determine one or more interest categories (block 404). In some implementations, webpage themes may be self-identified (i.e., within the webpage code and transparent to a visitor to the webpage). For example, a tag on a webpage may include self-identified themes for the webpage. In some implementations, webpage themes may be identified based on the content of a webpage identified in the history data. For example, a webpage devoted to golf may include text and/or images that may be used to identify the theme of the webpage as being golf. In some cases, both self-identified and content-based themes may be used to categorize a webpage. Identified webpage themes may then be matched to predefined interest categories, allowing interest categories to be associated with the user identifier. For example, the identified theme of “golf” may correspond to the interest category of /Entertainment/Sports, /Sports/Golf, /Outdoor Activities/Solo Sports/Golf, or a similar interest category.

Process 400 includes determining one or more geographic categories (block 406). Similar to the identification of interest categories, the history data may be used to identify one or more geographic categories. In some implementations, a geographic location may be self-identified by a webpage (e.g., via a metadata tag on the webpage, as part of a sitemap for a website, etc.). In other implementations, the content of a visited webpage may be analyzed using text and/or image recognition to identify one or more geographic locations. A location indicated by a webpage may be matched to predefined geographic category. For example, the indentified geographic location of “Kansas” may correspond to the geographic category of /USA/States/Kansas or /Word Localities/North America/USA/Kansas. In some implementations, other forms of location categories may be used, such as postal zip codes, telephonic country and/or area codes, longitudinal and latitudinal coordinates, or the like.

Process 400 includes associating a geographic category with an interest category (block 408). In various implementations, a geographic category may be associated with an interest category based in part on both categories being identified from the same webpage. For example, a webpage devoted to golf resorts in Alaska may be analyzed to identify both a golf-related interest category and a geographic category related to Alaska. In some implementations, only certain interest categories may have an associated geographic category. In other implementations, any interest category may have an associated geographic category.

Any number of geographic categories may be associated with an interest category. In implementations in which the number is limited, a weighting may be applied to the geographic categories. In some cases, a weighting for a geographic category may be based in part on the number of visits are made to webpages devoted to the geographic category and the corresponding interest category. For example, a geographic category relating to Hawaii may receive a greater weighting than one relating to Arizona, if a user identifier visits more webpages devoted to Hawaii within the same interest category. Other factors may also be used to determine a weighting for a geographic category. For example, a weighting for a geographic category may be based in part on the commercial value of the geographic category to an advertiser or other content provider, the distance between the geographic category and the location of a client device, or a performance metric for the geographic category (e.g., a click-through rate, a conversion rate, etc.).

In some implementations, the weighting for a geographic category may be based in part on a time decay function. The time decay function may cause the weighting for a geographic category to decrease over time. In other words, the weighting for a geographic category may be based in part on the number of times webpages having both the interest category and the geographic category were visited, as well as how recently these webpages were visited. In one example, assume that a user identifier visited more travel-related webpages devoted to Hawaiian vacations than travel-related webpages devoted to vacations in Florida. However, also assume that the visits to the webpages devoted to vacations in Florida occurred more recently. In such a case, the geographic category corresponding to Florida may receive a greater weighting than Hawaii. If the travel-related interest category is limited to one associated geographic category, the interest category may be associated with the Florida-related geographic category based on its weighting value.

Process 400 includes generating an IC profile for the user identifier (block 410). The IC profile includes the interest category and its associated geographic category identified from the history data associated with the user identifier. The IC profile may include an unlimited number of identified interest categories or a limited number of interest categories (e.g., the top ten interest categories, the top five interest categories, etc.). In cases in which the number of interest categories for an IC profile is limited, a weighting may be applied to each interest category to determine which interest categories are to be included in the IC profile. Such a weighting may be based in part on the number of visits to webpages devoted to the interest category from the history data, a performance metric for content related to the interest category (e.g., a click through rate, a conversion rate, etc.), an economic value of the interest category to advertisers and other content providers, a time decay function that decreases the weighting based on when the user identifier last visited a webpage devoted to the interest category, or other such factors.

The IC profile for a user identifier may be generated at any time. For example, the IC profile for the user identifier may be regenerated each time the user identifier visits a new webpage. In various implementations, the history data may be divided into long-term, short-term, and/or current history data. Current history data may include data regarding the most currently visited webpage by a user identifier. Short-term history data may include history data from the previous hour, several hours, twelve hours, twenty four hours, or a similar range. Long-term history data may be history data from any date range prior to that of the short-term history data. For example, the long-term history data may be history data between the previous day and thirty days prior. In another example, the long-term history data may include all history data prior to the short-term history data. Each of the sets of history data may be analyzed to identify interest and geographic categories. For example, long-term history data may be analyzed to identify long-term interest and geographic categories, short-term history data may be analyzed to identify short-term interest and geographic categories, and the current history data may be analyzed to identify a current interest and geographic category.

In some implementations, the long-term history data may be analyzed on a periodic basis, while the current and short-term history data may be analyzed whenever a new webpage is visited. For example, the long-term history data may be analyzed on a daily basis as part of a batch job. Doing so may conserve computing resources, since the long-term history data may be much larger than the short-term and current history data.

Long-term, short-term, and/or current interest categories may be weighted to determine which interest categories are to be included in an IC profile for a user identifier. For example, the IC profile may be limited to one current interest category, three short-term interest categories, and five long-term interest categories. In other cases, the weighting for an interest category may be based in part on whether the interest category is a long-term, short-term, or current interest category and the highest weighted interest categories included in the IC profile.

Process 400 includes proving content based in part on an IC profile (block 412). In some implementations, a content request may be sent by a client device to a content selection server when the device is used to visit a webpage. Content providers wishing to provide advertisements or other content of interest may compete to be able to provide their content in conjunction with the webpage. For example, the content selection server may automatically (i.e., without further user interaction) conduct an auction to determine which content is to be returned to the client device and presented with the webpage. In such a case, an advertiser may specify that an advertisement belongs to a particular interest category and other auction parameters that may be used in the auction (e.g., a maximum bid, a daily advertising budget, etc.).

In one example, an advertiser may create an advertising campaign via a content selection server. Such a campaign may specify that the advertiser wishes to spend a total of $1,000 per day on advertisements, is willing to spend up to $3 per advertisement clicked by a user, and wishes to provide advertisements to users that are interested in purchasing airline tickets to Las Vegas. When a client device visits a webpage that participates in the content selection network, a client identifier may be sent with a content selection request to the content selection server. The server may then run an auction to determine which content is to be returned to the client device and presented in conjunction with the webpage (e.g., appearing as part of the webpage, appearing in a pop-up window, etc.). If the IC profile associated with the client identifier includes an interest category of /Shopping/Airline Tickets that is associated with the geographic category of /World Localities/North America/USA/Cities/Las Vegas, the advertiser may automatically bid in the auction. If the advertiser is the winner of the auction, the advertiser's advertisement may then be returned to the client device and displayed as part of the webpage. The winner of the auction may be determined, for example, by determining which auction participant has the highest bid and/or the most relevant content based in part on the IC profile associated with the client device.

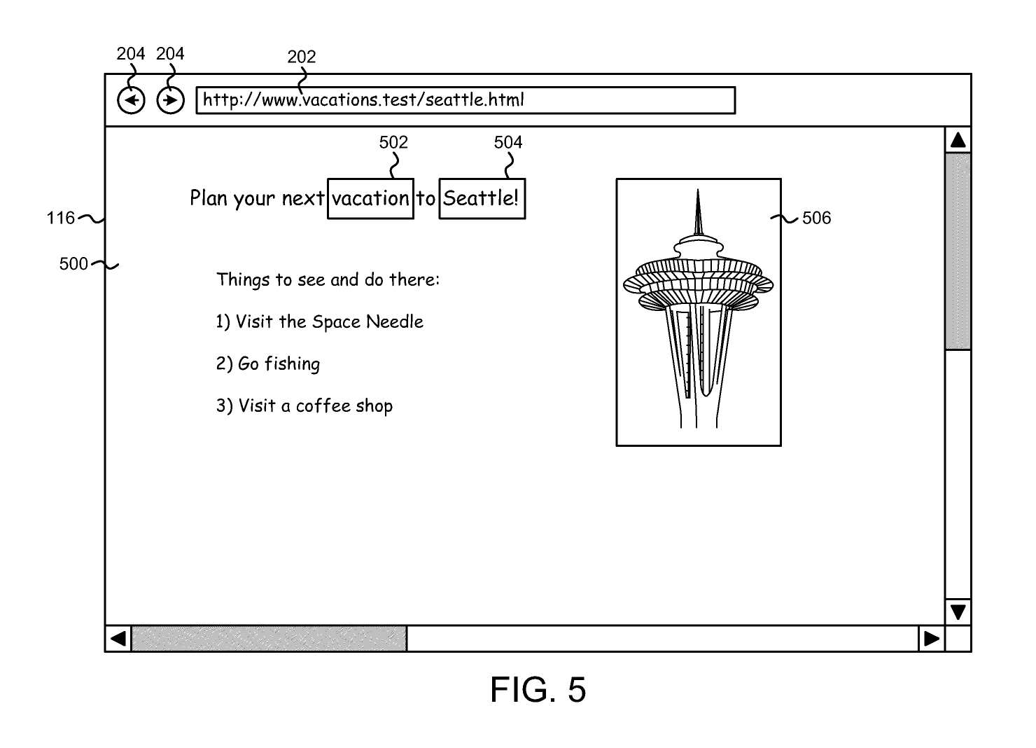

Referring now to FIG. 5, an illustration of a of a webpage 500 being analyzed to identify an interest category and a geographic location is shown, according to various implementations. Similar to the example shown in FIG. 2, client 102 may execute web browser 200 or another application to receive and display content. As shown, web browser 200 may be used to request webpage 500 from the content source corresponding to the URL entered via field 202 (i.e., http://www.vacations.test/seattle.html). In response, the content source may return webpage data for webpage 500 to client 102 and web browser 200 may use the webpage data to display webpage 500.

In the example shown, webpage 500 may be devoted to tourist attractions and activities available in Seattle, Wash. Webpage 500 may include various text, images, and other content (e.g., a movie, an audio stream, etc.) that may be analyzed to determine an interest category and/or a geographic category for the interest category. As shown, webpage 500 may include an image 506 of a location in Seattle, such as the Space Needle. In some implementations, image recognition may be used on image 506 to identify the Space Needle and its corresponding location, Seattle. Text recognition may be used on webpage 500 to identify keywords indicative of the topic and/or geographic location associated with webpage 500. For example, webpage 500 may include a keyword 502, “vacation,” that may be analyzed to identify webpage 500 as being related to travel. Similarly, a keyword 504, “Seattle,” may be analyzed to identify webpage 500 as being related to the geographic location of Seattle.

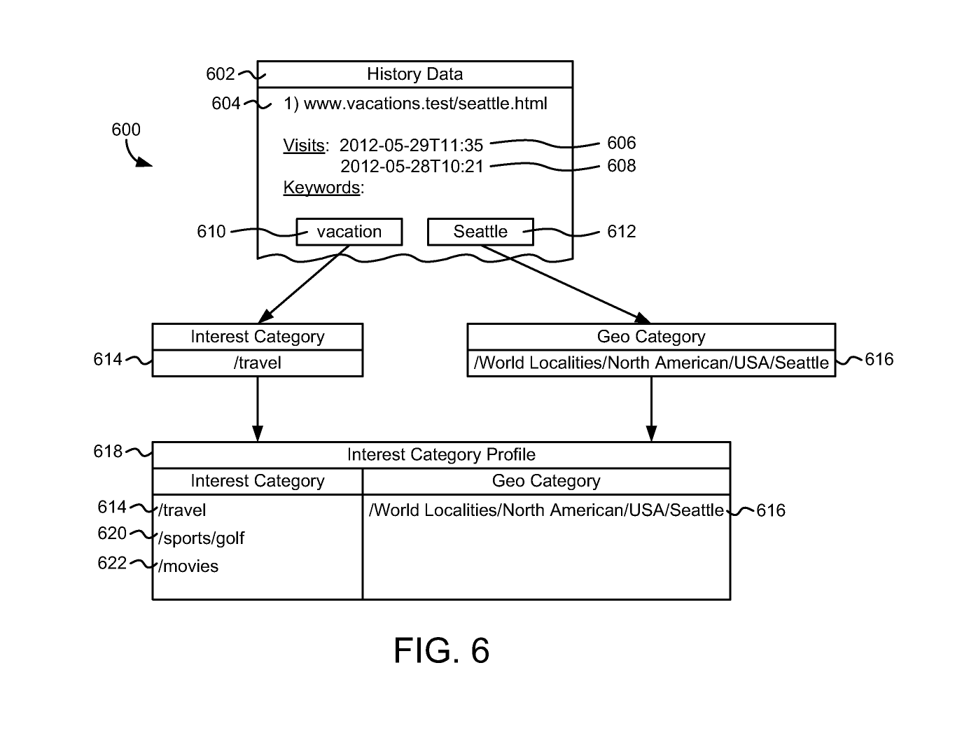

Referring now to FIG. 6, an example illustration 600 of an IC profile being generated is shown, according to various implementations. History data 602 associated with a user identifier may be analyzed to generate an IC profile 618. In the example shown, history data 602 may be from any timeframe. In other implementations, however, IC profile 618 may be generated by dividing history data 502 into any number of datasets (e.g., current history data, short-term history data, long-term history data, etc.). IC profile 618 may be used by a content selection server to select content for a client device associated with the user identifier by matching content to one of the interest categories within IC profile 618.

Continuing the example of FIG. 5, assume that a user identifier visits webpage 500 located at the URL, http://www.vacations.test/seattle.html. An indication 604 of this visit may be generated and received by a content selection server or other computing device when a client device visits webpage 500. For example, a cookie set on the client device may be sent with a request for webpage 500 and/or a content tag on webpage 500 may cause the client device to provide a cookie to a content selection server.

Indication 604 of a visit to webpage 500 may be associated with any number of timestamps that represent when webpage 500 was visited by the user identifier. The timestamps may correspond to when the webpage request for webpage 500 was received, when indication 604 is received by a content selection server, or at any other time associated with a visit to webpage 500. As shown, indication 604 may be associated with a first timestamp 606 that represents webpage 500 being visited on May 29, 2012 at 11:35 AM. Similarly, indication 604 may also be associated with a second timestamp 608 that represents another visit to webpage 500 on May 28, 2012 at 10:21 AM.

In some implementations, a number of keywords may be associated with webpage 500. For example, indication 604 may be associated with a keyword 610, “vacation,” and a keyword 612, “Seattle.” Keywords 610, 612 may be identified by performing text analysis on webpage 500, as shown in the example of FIG. 5. In other implementations, keywords 610, 612 may be identified by analyzing a metadata tag on webpage 500, included in a content tag and sent as part of a content request, specified as part of a sitemap, specified in a communication from the operator of webpage 500 (e.g., an email, instant message, etc.), included in conjunction with a link to webpage 500, or combinations thereof. In further implementations, a keyword associated with webpage 500 may be determined via image analysis.

Keyword 610 may be used to determine that webpage 500 relates to interest category 614 (e.g., the interest category, /travel). Interest category 614 may be associated with one or more keywords. For example, interest category 614 may be associated with the keywords, “vacation,” “travel,” “holiday,” etc. If one or more of the keywords appear on a particular webpage, the webpage may be identified as being related to interest category 614. In some implementations a term frequency, inverse document frequency (TF-IDF) score may be used to score a keyword identified on a webpage. The score may then be used to determine whether an interest category is to be associated with the webpage.

Similar to keyword 610, keyword 612 may be used to determine that webpage 500 also relates to geographic category 516. Geographic category 516 may be associated with various keywords, area codes, zip codes, etc. If such data matches data from webpage 500, geographic category 516 may be identified. For example, keyword 612 (e.g., “Seattle”), may be analyzed to determine that webpage 500 is related to the geographic category of /World Localities/North America/USA/Seattle. Also similar to keyword 610, TF-IDF scores may be applied to keywords for webpage 500 and used to determine whether webpage 500 is related to geographic category 516.

Interest category 614 may be associated with geographic category 616 based on keywords 610, 612 appearing together on webpage 500. In other words, geographic category 616 may be identified by analyzing the same data analyzed to identify interest category 614. Thus, geographic category 616 may be unrelated to the actual location of the client device that visited webpage 500. For example, a computer located in Massachusetts may access webpage 500. While the client device is located in Massachusetts, interest category 614 may not be associated with this location, since Massachusetts is not mentioned on webpage 500.

In some implementations, interest category 614 and/or geographic category 616 may receive weighting values. Such weightings may be based in part on the number of visits to webpages related to categories 614, 616. For example, history data 602 may indicate two visits to webpage 500. The weightings may also be based in part on the amount of time that has passed since a visit to webpage 500. For example, timestamps 606, 608 may be compared to the current time and date to determine how long has elapsed since the last visit. This time difference may be used with a time decay function to determine a weighting for interest category 614 or geographic category 616. Thus, weight values may be used to determine whether a geographic category is to be associated with an interest category and/or whether the interest category is to be included in IC profile 618,

In one example, assume that interest category 614 is associated with fifty webpage visits, as indicated by history data 602, and that the most recent visits are associated with a different geographic category than geographic category 616. Based in part on the amount of time that has elapsed and the time decay function for the category, interest category 614 may be associated with a different geographic category. However, if the most recent webpage visits associated with interest category 614 also relate to geographic category 616, then the two may be associated for purposes of generating IC profile 618.

IC profile 618 may include any number of interest categories. For example, IC profile 618 may include interest category 614, interest category 620 (e.g., /sports/golf), and interest category 622 (e.g., /movies). In some implementations, the number of interest categories in IC profile 618 may be limited. In such a case, weighting values for interest categories may be used to determine which interest categories are included in IC profile 618. For example, interest categories 614, 620-622 may be the highest weighted interest categories identified by analyzing history data 602. In some cases, the weighting values may be based in part on time decay functions. For example, a time decay function used to calculate the weighting value for interest category 614 may cause it to be phased out of IC profile 618 over time, if the user identifier stops visiting webpages related to interest category 614.

In some implementations, an interest category included in IC profile 618 may not have an associated geographic category. For example, interest categories 620-622 may not have associated geographic categories. A particular interest category may not be eligible for an associated geographic category or no geographic category was not identified for the interest category. For example, interest category 622 may not be eligible for an associated geographic category. In another example, interest category 620 may not have a geographic category based on the webpage content used to identify interest category 620.

IC profile 618 may be used to select content for the user identifier, based on whether the content corresponds to an interest category in IC profile 618. For example, a content provider, such as an advertiser, may specify that their advertisement is to be provided to those IC profiles having interest category 620. In some implementations, the advertiser may also specify a geographic category for the interest category. For example, an advertiser may specify both the interest category of /travel and the geographic category of /World Localities/North America/USA/Seattle. In some implementations, a higher level category may be specified and matched to all subcategories in IC profiles. For example, IC profile 618 may be used to select an advertisement associated with /travel and /World Localities/North America/USA.

An advertiser or other content provider may specify a geographic category for a client identifier, in some implementations. Such a geographic category may represent the location of the device receiving the selected content. In other words, this type of geographic category may differ from a location associated with an interest category. For example, an advertiser may specify that an advertisement is to be provided to devices in Boston, devices located in Boston and associated with a travel-related interest category, devices associated with a travel-related interest category associated with a Seattle-related geographic category, or devices associated with a travel-related interest category that is associated with a Seattle-related geographic category and located in Boston.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible and non-transitory.

The operations described in this specification can be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The features disclosed herein may be implemented on a smart television module (or connected television module, hybrid television module, etc.), which may include a processing circuit configured to integrate Internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

What is claimed is:

1. A computerized method for providing online content comprising:
receiving, at a processing circuit, history data indicative of a webpage visited by a user identifier;
analyzing, by the processing circuit, the history data to identify an interest category based in part on a topic of the webpage;
analyzing, by the processing circuit, the history data to identify a geographic location based in part on the webpage;
associating the geographic location with the interest category;
generating an interest category profile for the user identifier, the interest category profile comprising the identified interest category and associated geographic location;
selecting content for the user identifier based in part on the interest category profile; and
providing the selected content to a device associated with the user identifier.

2. The method of claim 1, wherein the interest category and geographic location are identified using text or image recognition on the webpage.

3. The method of claim 1, wherein the selected content is associated with the interest category and the geographic location.

4. The method of claim 1, wherein the content is selected via a content auction.

5. The method of claim 1, further comprising:
generating a weighting for the geographic location, wherein the geographic location is associated with the interest category based in part on the weighting.

6. The method of claim 5, wherein the weighting comprises a time-decay function.

7. The method of claim 1, wherein the interest category profile comprises an interest category that is not associated with a geographic location.

8. The method of claim 1, wherein the geographic location differs from a location of the device.

9. A system for providing online content comprising a processing circuit operable to:
receive history data indicative of a webpage visited by a user identifier;
analyze the history data to identify an interest category based in part on a topic of the webpage;
analyze the history data to identify a geographic location based in part on the webpage;
associate the geographic location with the interest category;
generate an interest category profile for the user identifier, the interest category profile comprising the identified interest category and associated geographic location;
select content for the user identifier based in part on the interest category profile; and
provide the selected content to a device associated with the user identifier.

10. The system of claim 9, wherein the interest category and geographic location are identified using text or image recognition on the webpage.

11. The system of claim 9, wherein the selected content is associated with the interest category and the geographic location.

12. The system of claim 9, wherein the content is selected via a content auction.

13. The system of claim 9, wherein the processing circuit is further operable to:
generate a weighting for the geographic location, wherein the geographic location is associated with the interest category based in part on the weighting.

14. The system of claim 13, wherein the weighting comprises a time-decay function.

15. The system of claim 9, wherein the interest category profile comprises an interest category that is not associated with a geographic location.

16. The system of claim 9, wherein the geographic location differs from a location of the device.

17. A computer-readable storage medium having machine instructions stored therein, the instructions being executable by a processor to cause the processor to perform operations, the operations comprising:
receiving history data indicative of a webpage visited by a user identifier;
analyzing the history data to identify an interest category based in part on a topic of the webpage;
analyzing the history data to identify a geographic location based in part on the webpage;
associating the geographic location with the interest category;
generating an interest category profile for the user identifier, the interest category profile comprising the identified interest category and associated geographic location;
selecting content for the user identifier based in part on the interest category profile; and
providing the selected content to a device associated with the user identifier.

18. The computer-readable storage medium of claim 17, wherein the interest category and geographic location are identified using text or image recognition on the webpage.

19. The computer-readable storage medium of claim 17, wherein the selected content is associated with the interest category and the geographic location.

20. The computer-readable storage medium of claim 17, wherein the geographic location differs from a location of the device.
